(19) United States
(12) Patent Application Publication
(10) Pub. No.: US 2021/0017454 A1
(43) Pub. Date: Jan. 21, 2021

(54) CRUDE OIL FRACTIONATION WITHOUT A VACUUM DISTILLATION UNIT

(71) Applicant: ExxonMobil Research and Engineering Company, Annandale, NJ (US)

(72) Inventor: Mohsen N. Harandi, New Hope, PA (US)

(21) Appl. No.: 16/930,864

(22) Filed: Jul. 16, 2020

Related U.S. Application Data
(60) Provisional application No. 62/875,154, filed on Jul. 17, 2019.

(51) Int. Cl. C10G 7/06; C10C 3/06; B01D 3/38; B01D 3/06; B01D 3/14

(52) U.S. Cl. CPC C10G 7/06; C10C 3/06; B01D 3/143; B01D 3/06; B01D 3/38

(57) ABSTRACT

A method of crude oil fractionation without using a vacuum distillation unit can include: introducing a crude oil feed having been preheated to an atmospheric distillation tower; introducing steam according to one of: (a) into the atmospheric heater at a weight ratio of 0.1:1 to 5:1 of the steam to the crude oil feed, (b) into the atmospheric distillation tower at a weight ratio of 0.1:1 to 5:1 of the steam to the crude oil feed, or (c) both (a) and (b); and distilling the crude oil feed in the atmospheric distillation tower into a plurality of cuts including an atmospheric bottoms cut having a boiling point of 800+° F. to 950+° F.

### CROSS REFERENCE TO RELATED APPLICATIONS

This application claims priority to U.S. Provisional Application Ser. No. 62/875,154 filed Jul. 17, 2019, which is herein incorporated by reference in its entirety.

### BACKGROUND

The present disclosure relates to crude oil fractionation.

Separation units, such as atmospheric distillation units, vacuum distillation units, and product strippers, are major processing units in a refinery. Atmospheric or vacuum distillation units separate crude oil into fractions according to boiling point so downstream processing units, such as catalytic cracking, hydrogen treating, or reforming units, will have feedstocks that meet particular specifications. Crude oil separation is accomplished by fractionating the total crude oil at essentially atmospheric pressure and then feeding a bottoms stream of high boiling hydrocarbons, also known as topped crude or long resid, from the atmospheric distillation unit to a second distillation unit operating at a reduced pressure (vacuum). The bottoms fraction in the atmospheric distillation unit typically contains components of the crude oil with a boiling point of 650° F. and greater (also referred to herein as 650+° F.). The bottoms fraction separated from crude oil in the atmospheric distillation unit is fed to a flash zone in the lower portion of the vacuum tower.

The vacuum distillation unit typically separates the atmospheric unit bottoms into gas oil vapors based on boiling point, including light vacuum gas oil, heavy vacuum gas oil, lube oil distillates, and vacuum reduced crude. The non-distillable residual fraction from the vacuum tower, also known as vac resid or short resid, leaves the vacuum distillation unit as a heavy, viscous, liquid bottoms stream, which can be used in the production of asphalt for example.

Vacuum tower construction and operation has become rather specialized by reason of the operating requirements, which include the need to handle very large volumes of vapor. Further, because the resid feed includes a high boiling hydrocarbon that have to be separated at very high temperatures (e.g., greater than 950° F.), any oxygen that enters the vacuum tower can cause coking and a lower vacuum. Unfortunately, vacuum towers by virtue of being under vacuum are prone to leaks. As a result of these trying operating requirements, the design of the vacuum tower has taken on its own characteristics not generally shared by other units.

### SUMMARY

The present disclosure relates to crude fractionation without using a vacuum distillation unit.

A method of the present disclosure can include: passing a crude oil feed through an atmospheric heater; introducing a crude oil feed to an atmospheric distillation tower; introducing steam according to one of: (a) into the atmospheric heater at a weight ratio of 0.1:1 to 5:1 of the steam to the crude oil feed, (b) into the atmospheric distillation tower at a weight ratio of 0.1:1 to 5:1 of the steam to the crude oil feed, or (c) both (a) and (b); and distilling the crude oil feed in the atmospheric distillation tower into a plurality of cuts including an atmospheric bottoms cut having a boiling point of 800+° F. to 950+° F.

Another method of the present disclosure can include: introducing a crude oil feed preheated to 600° F. to 950° F. into an atmospheric distillation tower; introducing steam and light hydrocarbons into the atmospheric distillation tower such that the steam and light hydrocarbons cumulatively are introduced to the atmospheric distillation tower at a weight ratio of 0.1:1 to 5:1 of the steam and light hydrocarbons cumulatively to the crude oil feed and the steam is introduced to the atmospheric distillation tower at a weight ratio of 0.1:1 to 1:1 of the steam to the crude oil feed; distilling the crude oil feed into a plurality of cuts including an overheads cut and an atmospheric bottoms cut having a boiling point 800+° F. to 950+° F.; separating the overheads cut outside of the atmospheric distillation tower into a naphtha cut and a light hydrocarbons cut; and recycling at least a portion of the light hydrocarbons cut back into the atmospheric distillation tower at a location lower than the flash zone.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an example system of the present disclosure for fractionating crude oil feeds without using a vacuum distillation unit.

### DETAILED DESCRIPTION

The present disclosure relates to crude fractionation without using a vacuum distillation unit. That is, the methods and systems described herein that use an atmospheric distillation unit without a vacuum distillation unit can achieve atmospheric bottoms cuts of 800+° F. to 950+° F. that previously required a vacuum distillation unit. By eliminating the vacuum distillation unit, the associated hardware like the pump-around system, compressor, and furnace are eliminated. Accordingly, cost savings can be realized in the reduced equipment costs, reduced operating energy costs, and reduced refinery footprint of the equipment.

Generally, the methods and systems described herein use significantly higher gas flows than traditionally used in atmospheric distillation units. Without being limited by theory, it is believed that using light hydrocarbons and/or steam at high flow reduces the partial pressure of the feed components, which to some extent mimics vacuum conditions and, consequently, provides improved fractionation.

Further, the methods and systems described herein can optionally use recycled light hydrocarbons (e.g., primarily C₁-C₄) fractionated in the atmospheric tower to replace portions of the steam. In these instances, the light hydrocarbons may act as the medium for deep stripping of the crude oil feedstock. The steam is used at least in low concentrations to strip trace hydrocarbons left after the deep stripping.

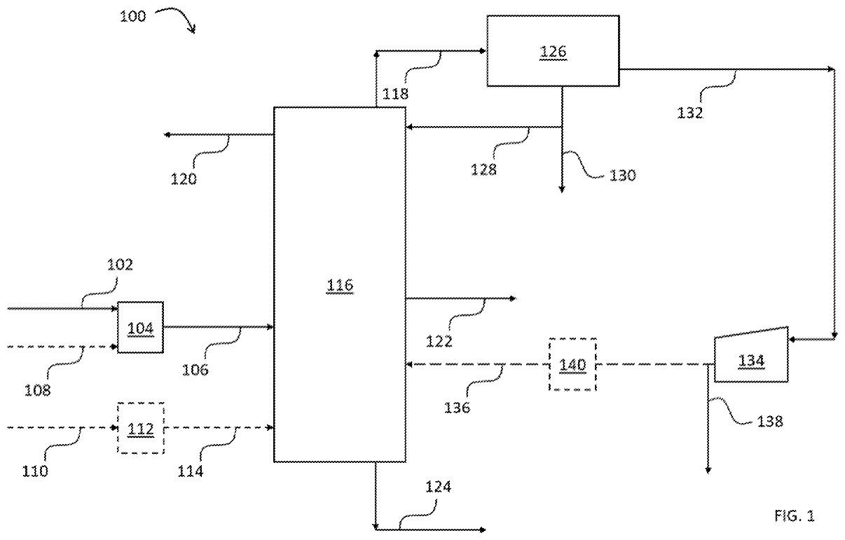

FIG. 1 illustrates an example system 100 of the present disclosure for fractionating crude oil feeds without using a vacuum distillation unit. A crude oil feed (e.g., a crude oil, a crude slate, and/or a crude emulsion) is conveyed to and preheated in an atmospheric heater 104 via line 102 to produce preheated crude oil feed that then introduced into an atmospheric distillation tower 116 via line 106. The crude oil feed is preferably preheated before introduction into the atmospheric distillation tower 116, for example, to temperatures of 600° F. to 950° F., or 600° F. to 850° F., or 700° F. to 800° F.

The system 100 also uses steam, which may be introduced to the system in one or more of the following: (a) via line 108 to the atmospheric heater 104 where the crude oil feed and steam mix in the atmospheric heater 104 before introduction into the atmospheric distillation tower 116 via line 106; (b) premixed with the crude oil feed and introduced to the atmospheric heater 104 via line 102 to the atmospheric heater 104 before introduction into the atmospheric distillation tower 116 via line 106; (c) separately heated in a steam heater 112 and introduced via line 110 to the steam heater 112 before introduction into the atmospheric distillation tower 116 via line 114, or a combination of two or more of the foregoing. Preferably, a portion of un-preheated steam is added to the crude as it is heated in the atmospheric furnace upstream of the atmospheric distillation tower.

When steam is preheated in the steam heater 112, the steam can be preheated before introduction into the atmospheric distillation tower 116, for example, to temperatures of 500° F. to 1500° F., or 750° F. to 1000° F., or 650° F. to 850° F.

The atmospheric distillation tower 116 has different zones with different temperatures. Typically, the lowest temperature is at the top and the zone temperatures increase down the atmospheric distillation tower 116. When steam is preheated in the steam heater 112, the steam is fed into the atmospheric distillation tower 116 at a lower height than the preheated crude oil feed. The steam (via any disclosed introduction method) flashes the un-flashed crude oil feed and causes the components of the crude oil feed to separate by boiling point as a function of the different temperature zones in the atmospheric distillation tower 116.

As illustrated, four cuts are collected in this atmospheric distillation tower 116: an overheads cut (preferably boiling point of less than about 430° F.) at line 118, a diesel cut (preferably boiling point of about 430° F. to about 700° F.) at line 120, a light vacuum gas oil cut (preferably boiling point of about 700° F. to about 900° F.) at line 122, and an atmospheric bottoms cut (boiling point of about 900+° F.) at line 124. Other cuts can be collected depending on the configuration and operational parameters of the atmospheric distillation tower 116. For example, the atmospheric bottoms cuts can have a boiling point of 800+° F., or 850+° F., or 900+° F., or 950+° F.

The overheads cut is conveyed from the atmospheric distillation tower 116 to an overhead drum system 126 via line 118. In the overhead drum system 126, the overheads cut is further separated into a naphtha cut and a light hydrocarbons cut. The naphtha cut is conveyed, in part, back to the atmospheric distillation tower 116 via line 128 as reflux and, in part, to another portion of the refinery for upgrading and/or storage via line 130. While the separation of the overheads cut is illustrated as performed outside the atmospheric distillation tower 116 in the present example (which is preferable), such separation can be done in the atmospheric distillation tower 116.

The light hydrocarbons cut is conveyed from the overhead drum system 126 via line 132 to a compressor 134. The compressed light hydrocarbons cut can then be recycled back to the atmospheric distillation tower 116 via line 136 and/or to another portion of the refinery for use and/or storage via line 138. Optionally, a light hydrocarbons heater 140 is included to preheat the light hydrocarbons. Alternatively (not shown), the compressed light hydrocarbons can be passed through the atmospheric heater 104 and/or the steam heater 112 before being introduced into the atmospheric distillation tower 116.

The light hydrocarbons cut can be preheated before introduction into the atmospheric distillation tower 116, for example, to temperatures of 500° F. to 800° F., or 650° F. to 750° F. As illustrated, the light hydrocarbons heater 140 is between the compressor 134 and the atmospheric distillation tower 116. However, the light hydrocarbons heater 140 can be placed anywhere along the system 100 between the overhead drum system 116 and the atmospheric distillation tower 116. In the most preferred case, no steam heater or light hydrocarbon heater is installed for cost efficiency and a significant part of these streams are fed with crude to atmospheric heater.

Optionally, a portion of the steam injected into the atmospheric distillation tower 116 can be replaced with the compressed light hydrocarbons cut via line 126. The light hydrocarbons are fed into the atmospheric distillation tower 116 at a vertical level below where the crude oil feed is fed in. This allows for the light hydrocarbons to be the primary stripping gas in such methods.

A flash zone of the atmospheric distillation tower 116 (which is approximately where the preheated crude oil feed is introduced) can be operated at 700° F. to 950° F., or 750° F. to 900° F., or 700° F. to 850° F. Typically, in systems that include a vacuum tower, the flash zone of the atmospheric distillation tower is less than 700° F., and preferably less than 650° F. Operating at higher temperatures without significant coking is achieved by distilling with a significant amount of steam (or steam and light hydrocarbon combination, described further herein) and using heater coils designed for a relatively high gas velocity. The injection flow of gas other than components of the crude oil feed (e.g., steam and/or light hydrocarbons) into the atmospheric heater 104 can be at a weight ratio of 0.1:1 to 2:1 of the other gas to the crude oil feed. Additional steam and light hydrocarbons can be used in the atmospheric tower to strip light vacuum gas oil components from the bottoms product.

When steam is used exclusively, the steam is introduced (via any system configuration or mixture of system configurations described herein) into the atmospheric distillation tower 116 at a weight ratio of 0.1:1 to 5:1, or 1:1 to 3:1, or 1:1 to 2:1 of the steam to the crude oil feed. When a portion of the steam is replaced with light hydrocarbons, the steam and light hydrocarbons cumulatively are introduced into the atmospheric distillation tower 116 at a weight ratio of 0.1:1 to 5:1, or 1:1 to 3:1, or 1:1 to 2:1 of the steam and light hydrocarbons cumulatively to the crude oil feed, and the steam is present at a weight ratio of 1:1 or less, or 0.1:1 to 1:1, or 0.5:1 of the steam to the crude oil feed based on the crude oil feed. Maintaining some steam in the atmospheric distillation tower 116 is preferably to maintain a desired viscosity and flashpoint of the atmospheric bottoms cut.

The outlet temperature of the heater coil in the atmospheric heater 104 effects the temperature of the flash zone. Higher heater coil outlet temperatures allow for the easier recovery of an atmospheric bottoms cut that meets asphalt, fuel oil blending stock, or fuel oil specifications. However, the higher temperature at the heater coil outlet will cause more rapid coking and fouling. Therefore, an atmospheric heater 104 may be designed to run at the higher temperature like 750° F. to 950° F. should also be designed to allow for on-line decoking facilities or provide a divided heater design wherein a portion of the heater is taken offline and cleaned before returning to process crude. The frequency of decoking depends on the type of crude and the process parameters and can be monthly to annually. Operating at the lower temperature range may allow decoking just be conducted during a scheduled turn-around, which can take place every three to eight years.

Preferably, a pressure drop across the atmospheric distillation tower 116 (from the steam inlet to the overheads outlet) is minimized by appropriate tower sizing and tray design. The pressure drop across the atmospheric distillation tower 116 may be 30 psi gauge (psi) or less, or 1 psi to 10 psi, or 1 psi to 5 psi.

As used herein, when describing components of a system that are fluidly coupled, the fluid coupling refers to fluids being able to travel from one component to the other or between components. When traversing a fluid coupling, the fluid may travel through hardware like lines, pipes, pumps, connectors, heat exchangers, and valves that ensure proper operation and safety measures when operating the system. As used herein, when describing components and/or lines being configured for delivery, configured for receiving, or configured for conveying (or grammatical variations thereof), this provides a fluid flow direction and can include other components (if needed like pumps) or use pressure differences to effect the flow of the fluid.

Accordingly, a system of the present disclosure can include an atmospheric distillation tower 116 fluidly coupled to a atmospheric heater 104 and configured to receive a preheated crude feed from the atmospheric heater 104 via a preheated crude feed line 106; an overhead drum system 126 fluidly coupled to the atmospheric distillation tower 116 and configure to receive an overheads cut from the atmospheric distillation tower 116 via an overheads cut line 118; a compressor 134 fluidly coupled to the overhead drum system 126 and configured to receive light hydrocarbons from the overhead drum system 126 via a light hydrocarbons cut line 132; and one or more of the following: (a) a first steam line 108 fluidly coupled to the atmospheric heater 104 and configured to deliver steam to the atmospheric heater 104; (b) a crude feed/steam line 102 fluidly coupled to the atmospheric heater 104 and configured to deliver a mixture of crude feed and steam to the atmospheric heater 104; and (c) a preheated steam line 114 fluidly coupled to the atmospheric distillation tower 116 and configured to deliver steam to the atmospheric distillation tower 116. The system can further include a light hydrocarbons recycle line 136 (optionally with a light hydrocarbons heater 140 therealong) fluidly coupling the compressor 134 and the atmospheric distillation tower 116 and configured for conveying light hydrocarbons from the compressor 134 to the atmospheric distillation tower 116.

Further, a method of the present disclosure can include introducing a crude oil feed to an atmospheric distillation tower; passing the crude oil feed through an atmospheric heater before introduction to the atmospheric distillation tower; introducing steam according to one of: (a) into the atmospheric heater at a weight ratio of 0.1:1 to 5:1 of the steam to the crude oil feed, (b) into the atmospheric distillation tower at a weight ratio of 0.1:1 to 5:1 of the steam to the crude oil feed, or (c) both (a) and (b); and distilling the crude oil feed in the atmospheric distillation tower into a plurality of cuts including an atmospheric bottoms cut having a boiling point of 800+° F. to 950+° F. Further, the method can include wherein the plurality of cuts further includes an overheads cut and the method further comprises: separating the overheads cut outside of the atmospheric distillation tower into a naphtha cut and a light hydrocarbons cut; and recycling at least a portion of the light hydrocarbons cut back into the atmospheric distillation tower such that the steam and light hydrocarbons cumulatively are introduced to the atmospheric distillation tower at a weight ratio of 0.1:1 to 5:1 of the steam and light hydrocarbons cumulatively to the crude oil feed and the steam is introduced to the atmospheric distillation tower at a weight ratio of 0.1:1 to 1:1 of the steam to the crude oil feed.

The atmospheric bottoms cut can be used for producing asphalt, fuel oil blending stock, or fuel oil. Asphalt can be produced in many grades defined by their viscosity and flashpoint. For example, the viscosity at 135° C. can be 250 centistokes (cSt) or higher and the flashpoint can be 230° C. and higher. Different applications utilize asphalt with different viscosity and flashpoint. For example, paving asphalt typically has a viscosity at 135° C. of 200 cSt to 375 cSt or higher and a flashpoint of 325° C. to 375° C. In another example, roofing asphalt typically has a viscosity at 135° C. of 150 cSt to 250 cSt or higher and a flashpoint of 150° C. to 250° C. Advantageously, the boiling point of the atmospheric bottoms cut of the present methods and systems can be adjusted so that the atmospheric bottoms cut can be used with minimal blending with lower boiling point hydrocarbons to produce a desired asphalt grade. Asphalt quality can be varied by the fractionation cut-point set by the operating parameters. This is important as different geographic regions have different asphalt quality requirements. In addition, this system can also make fuel oil blending stock and/or fuel oil by ensuring flashpoint and viscosity is controlled by the fractionation parameters.

### Example Embodiments

A first nonlimiting example embodiment of the present disclosure is a method comprising: introducing a crude oil feed to an atmospheric distillation tower; passing the crude oil feed through an atmospheric heater before introduction to the atmospheric distillation tower; introducing steam according to one of: (a) into the atmospheric heater at a weight ratio of 0.1:1 to 5:1 of the steam to the crude oil feed, (b) into the atmospheric distillation tower at a weight ratio of 0.1:1 to 5:1 of the steam to the crude oil feed, or (c) both (a) and (b); and distilling the crude oil feed in the atmospheric distillation tower into a plurality of cuts including an atmospheric bottoms cut having a boiling point of 800+° F. to 950+° F. The first nonlimiting example embodiment can optionally further include one or more of the following: Element 1: the method further comprising: preheating the crude oil feed to 600° F. to 950° F. before introduction to the atmospheric distillation tower; Element 2: the method further comprising: preheating the steam to 500° F. to 1500° F. before introduction to the atmospheric distillation tower; Element 3: wherein a flash zone of the atmospheric distillation tower is at 700° F. to 950° F.; Element 4: wherein the plurality of cuts further includes an overheads cut and the method further comprises: separating the overheads cut outside of the atmospheric distillation tower into a naphtha cut and a light hydrocarbons cut; and recycling at least a portion of the light hydrocarbons cut back into the atmospheric distillation tower such that the steam and light hydrocarbons cumulatively are introduced to the atmospheric distillation tower at a weight ratio of 0.1:1 to 5:1 of the steam and light hydrocarbons cumulatively to the crude oil feed and the steam is introduced to the atmospheric distillation tower at a weight ratio of 0.1:1 to 1:1 of the steam to the crude oil feed; Element 5: Element 4 and preheating a light hydrocarbons cut to 600° F. to 800° F. before introduction to the atmospheric distillation tower; Element 6: the method further comprising: producing asphalt, fuel oil blending stock, or fuel oil from the atmospheric bottoms cut; Element 7: wherein the atmospheric bottoms cut has a boiling point 900+° F. to 950+° F. ; and Element 8: wherein the crude oil feed comprises a feed selected from the group consisting of: a crude oil, a crude slate, a crude emulsion, and mixtures thereof. Examples of combinations include: Element 1 in combination with one or more of Elements 2-8; Element 2 in combination with one or more of Elements 3-8; Element 3 in combination with one or more of Elements 4-8; Element 4 (and optionally Element 5) in combination with one or more of Elements 6-8; and two or more of Elements 6-8 in combination.

A second nonlimiting example embodiment is a method comprising: introducing a crude oil feed preheated to 600° F. to 950° F. into an atmospheric distillation tower; introducing steam and light hydrocarbons into the atmospheric distillation tower such that the steam and light hydrocarbons cumulatively are introduced to the atmospheric distillation tower at a weight ratio of 0.1:1 to 5:1 of the steam and hydrocarbons cumulatively to the crude oil feed and the steam is introduced to the atmospheric distillation tower at 0 a weight ratio of 0.1:1 to 1:1 of the steam to the crude oil feed; distilling the crude oil feed into a plurality of cuts including an overheads cut and an atmospheric bottoms cut having a boiling point 800+° F. to 950+° F.; separating the overheads cut outside of the atmospheric distillation tower into a naphtha cut and a light hydrocarbons cut; and recycling at least a portion of the light hydrocarbons cut back into the atmospheric distillation tower at a location lower than the flash zone. The second nonlimiting example embodiment can further include one or more of the following: Element 2; Element 3; Element 6; Element 7; Element 8; and Element 9: the method further comprising: preheating a light hydrocarbons cut to 600° F. to 950° F. before introduction to the atmospheric distillation tower. Examples of combination include Elements 2 and 3 in combination; one or both of Elements 2 and 3 in combination with one or more of Elements 6-9; and two or more of Elements 6-9 in combination.

Unless otherwise indicated, all numbers expressing quantities of ingredients, properties such as molecular weight, operating conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
passing a crude oil feed through an atmospheric heater;
introducing the crude oil feed to an atmospheric distillation tower after passing the crude oil feed through the atmospheric heater;
introducing steam according to one of:
(a) into the atmospheric heater at a weight ratio of 0.1:1 to 5:1 of the steam to the crude oil feed,
(b) into the atmospheric distillation tower at a weight ratio of 0.1:1 to 5:1 of the steam to the crude oil feed, or
(c) both (a) and (b); and
distilling the crude oil feed in the atmospheric distillation tower into a plurality of cuts including an atmospheric bottoms cut having a boiling point of 800+° F. to 950+° F.

2. The method of claim 1 further comprising:
preheating the crude oil feed to 600° F. to 950° F. before introduction to the atmospheric distillation tower.

3. The method of claim 1 further comprising:
preheating the steam to 500° F. to 1500° F. before introduction to the atmospheric distillation tower.

4. The method of claim 1, wherein a flash zone of the atmospheric distillation tower is at 700° F. to 950° F.

5. The method of claim 1, wherein the plurality of cuts further includes an overheads cut and the method further comprises:
separating the overheads cut outside of the atmospheric distillation tower into a naphtha cut and a light hydrocarbons cut; and
recycling at least a portion of the light hydrocarbons cut back into the atmospheric distillation tower such that the steam and light hydrocarbons cumulatively are introduced to the atmospheric distillation tower at a weight ratio of 0.1:1 to 5:1 of the steam and light hydrocarbons cumulatively to the crude oil feed and the steam is introduced to the atmospheric distillation tower at a weight ratio of 0.1:1 to 1:1 of the steam to the crude oil feed.

6. The method of claim 5 further comprising:
preheating a light hydrocarbons cut to 600° F. to 800° F. before introduction to the atmospheric distillation tower.

7. The method of claim 1 further comprising:
producing asphalt, fuel oil blending stock, or fuel oil from the atmospheric bottoms cut.

8. The method of claim 1, wherein the atmospheric bottoms cut has a boiling point 900+° F. to 950+° F.

9. The method of claim 1, wherein the crude oil feed comprises a feed selected from the group consisting of: a crude oil, a crude slate, a crude emulsion, and mixtures thereof.

10. A method comprising:
introducing a crude oil feed preheated to 600° F. to 950° F. into an atmospheric distillation tower;
introducing steam and light hydrocarbons into the atmospheric distillation tower such that the steam and light hydrocarbons cumulatively are introduced to the atmospheric distillation tower at a weight ratio of 0.1:1 to 5:1 of the steam and light hydrocarbons cumulatively to the crude oil feed and the steam is introduced to the atmospheric distillation tower at a weight ratio of 0.1:1 to 1:1 of the steam to the crude oil feed;
distilling the crude oil feed into a plurality of cuts including an overheads cut and an atmospheric bottoms cut having a boiling point 800+° F. to 950+° F.;
separating the overheads cut outside of the atmospheric distillation tower into a naphtha cut and a light hydrocarbons cut; and
recycling at least a portion of the light hydrocarbons cut back into the atmospheric distillation tower at a location lower than the flash zone.

11. The method of claim 10 further comprising:
preheating a steam to 500° F. to 1500° F. before introduction to the atmospheric distillation tower.

12. The method of claim 10, wherein a flash zone of the atmospheric distillation tower is at 700° F. to 950° F.

13. The method of claim 10, further comprising:
preheating a light hydrocarbons cut to 600° F. to 950° F. before introduction to the atmospheric distillation tower.

14. The method of claim 10, further comprising:
producing asphalt, fuel oil blending stock. or fuel oil from the atmospheric bottoms cut.

15. The method of claim 10, wherein the atmospheric bottoms cut has a boiling point 900+° F. to 950+° F.

16. The method of claim 10, wherein the crude oil feed comprises a feed selected from the group consisting of: a crude oil, a crude slate, a crude emulsion, and mixtures thereof.
